(19) United States
(12) Patent Application Publication
(10) Pub. No.: US 2025/0323444 A1
(43) Pub. Date: Oct. 16, 2025

(54) Connector Assembly

(71) Applicants: Tyco Electronics (Suzhou) Ltd., Suzhou City (CN); Tyco Electronics (Shanghai) Co., Ltd., Shanghai (CN)

(72) Inventors: Key Li, Suzhou (CN); Feng (Charles) Wan, Shanghai (CN); Zhaowen Zhou, Shanghai (CN)

(73) Assignees: Tyco Electronics (Suzhou) Ltd., Suzhou City (CN); Tyco Electronics (Shanghai) Co., Ltd., Shanghai (CN)

(21) Appl. No.: 19/175,405

(22) Filed: Apr. 10, 2025

(30) Foreign Application Priority Data
Apr. 10, 2024 (CN) 202420724240.5

(51) Int. Cl. H01R 13/436; H01R 13/52

(52) U.S. Cl. CPC H01R 13/4361; H01R 13/5202

(57) ABSTRACT

A connector assembly includes a housing having a port and a terminal position locking device detachably inserted into the port. The port is defined by a pair of first sides of the housing separated in a first direction and a pair of second sides of the housing separated in a second direction perpendicular to the first direction. A pair of outer surfaces of the second sides are each provided with a block. The terminal position locking device is inserted into the port in a third direction perpendicular to both the first direction and the second direction. The terminal position locking device has a locking hook arm disposed on each of a pair of opposite sides of the terminal position locking device. The terminal position locking device is in a pre-locking position relative to the housing when a hook portion of the locking hook arm abuts against the block.

### CROSS-REFERENCE TO RELATED APPLICATION

This application claims the benefit of the filing date under 35 U.S.C. § 119(a)-(d) of Chinese Patent Application No. 202420724240.5, filed on Apr. 10, 2024.

### FIELD OF THE INVENTION

The present disclosure relates to a connector assembly.

### BACKGROUND OF THE INVENTION

There is currently a type of connector assembly with a terminal position locking device on the market (e.g., AMPSEAL connectors used on engines or gearboxes, under shields, on power control units, on bulkheads, and on chassis to provide excellent reliability and environmental scaling). This type of connector assembly requires pre-locking of the terminal position locking device on a connector housing at the manufacturer to ensure that the terminal position locking device will not fall off the connector housing during factory delivery. However, the user must also push the terminal position locking device from a pre-locking position to a final-locking position after inserting all terminals to achieve position locking of the terminals.

In this type of existing connector assembly, the connector housing is provided with a locking hook arm, and the terminal position locking device is provided with a locking mating block. Specifically, a pair of locking hook arms extend from opposite sides of a port of the connector housing, for receiving the terminal position locking device. The terminal position locking device is provided with corresponding first and second locking mating blocks at positions corresponding to the pair of locking hook arms.

At the manufacturer, the terminal position locking device is pre-installed into the port of the connector housing, and hook portions of the pair of locking hook arms slide through the first locking mating block and are snap-fitted with the first locking mating block, so that the terminal position locking device is in the pre-locking position relative to the connector housing. At the user, after all terminals are installed, the terminal position locking device is further pushed into the port of the connector housing, during which the hook portions of the pair of locking hook arms continue to slide through the second locking mating block and are snap-fitted with the second locking mating block, so that the terminal position locking device is in the final-locking position relative to the connector housing.

However, according to the above-mentioned existing design of this type of connector assembly, because there is a gap between the first locking mating block and the second locking mating block, the hook portions of the pair of locking hook arms may slide through the second locking mating block and be snap-fitted with the second locking mating block during the delivery of the connector assembly, so that the terminal position locking device enters the final-locking position in advance, and the terminal is unable to be smoothly installed by the user.

In addition, according to the above-mentioned existing design of this type of connector assembly, the snap-fitting positions between the locking hook arm and the first and the second locking mating blocks are both positioned inside the port. Therefore, when there is a need to perform an unlocking operation of the terminal position locking device (for example, maintenance of the connector assembly is required), an additional tool needs to be used to extend into the port of the connector housing to release the snap-fitting between the locking hook arm and the locking mating block. In addition, according to the above-mentioned existing design of this type of connector assembly, a large unlocking force is usually required when performing the unlocking operation of the terminal position locking device. Therefore, it is inconvenient for the user and/or for maintenance by the user.

### SUMMARY OF THE INVENTION

A connector assembly includes a housing having a port and a terminal position locking device detachably inserted into the port. The port is defined by a pair of first sides of the housing separated in a first direction and a pair of second sides of the housing separated in a second direction perpendicular to the first direction. A pair of outer surfaces of the second sides are each provided with a block. The terminal position locking device is inserted into the port in a third direction perpendicular to both the first direction and the second direction. The terminal position locking device has a locking hook arm disposed on each of a pair of opposite sides of the terminal position locking device. The terminal position locking device is in a pre-locking position relative to the housing when a hook portion of the locking hook arm abuts against the block.

### BRIEF DESCRIPTION OF THE DRAWINGS

The invention will become apparent from the following description taken in conjunction with the accompanying drawings, and may help to provide a comprehensive understanding of the present disclosure, in which:

FIG. 1 is a schematic perspective view of a structure of a connector assembly according to an exemplary embodiment of the present disclosure;

FIG. 2 is a schematic top view of the structure of the connector assembly shown in FIG. 1;

FIG. 3 is a schematic front view of the structure of the connector assembly shown in FIG. 1;

FIG. 4 is a schematic cross-sectional view of the structure of the connector assembly in FIG. 1 taken along a line B-B, wherein a terminal position locking device is in a pre-locking position relative to a connector housing;

FIG. 5 is another schematic cross-sectional view of the structure of the connector assembly in FIG. 1 taken along the line B-B, wherein the terminal position locking device is in a final-locking position relative to the connector housing; and

FIG. 6 is a schematic cross-sectional view of the structure of the connector assembly in FIG. 1 taken along a line A-A, wherein the terminal position locking device is in the pre-locking position relative to the connector housing.

### DETAILED DESCRIPTION

Although the present disclosure will be fully described with reference to the drawings containing embodiments of the present disclosure, it should be understood that those skilled in the art may modify the present disclosure described herein and obtain the technical effect of the present disclosure. Therefore, it is necessary to understand that the description herein is a broad disclosure for those skilled in the art and is not intended to limit the exemplary embodiments described in the present disclosure.

In addition, in the following detailed description, for the sake of explanation, numerous specific details are set forth in order to provide a thorough understanding of the disclosed embodiments. It will be apparent, however, that one or more embodiments may also be practiced without these specific details. In other instances, well-known structures and devices are illustrated schematically in order to simplify the drawing.

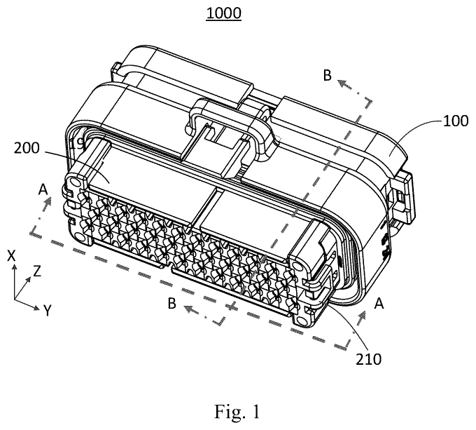

Referring to FIGS. 1 to 6, according to an exemplary embodiment of the present disclosure, there is provided a connector assembly 1000. The connector assembly 1000 includes a housing 100, a terminal position locking device 200, a sealing ring 300, and other components. The housing 100 and the terminal position locking device 200 may be made of, e.g., plastic material, and the sealing ring 300 may be made of, e.g., rubber material.

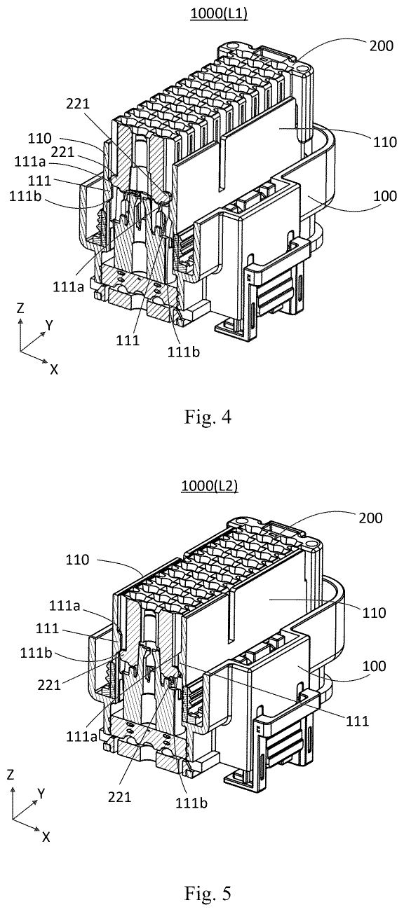

At the manufacturer, the terminal position locking device 200 is in a pre-locking position (for example, the L1 position shown in FIG. 4) relative to housing 100. At this moment, the terminal has not yet been installed into the housing 100. At the user, after all terminals are inserted, the terminal position locking device 200 may be manually pushed from the pre-locking position to a final-locking position (for example, the L2 position shown in FIG. 5) to achieve position locking of the terminals. It should be noted that, in order to clearly show the mating structure and mating relationship between the housing 100 and the terminal position locking device 200 in the connector assembly 1000, the terminal that is inserted into both a terminal channel of the housing 100 and a terminal channel of the terminal position locking device 200 and that is locked by the terminal position locking device 200 is not shown in the drawings.

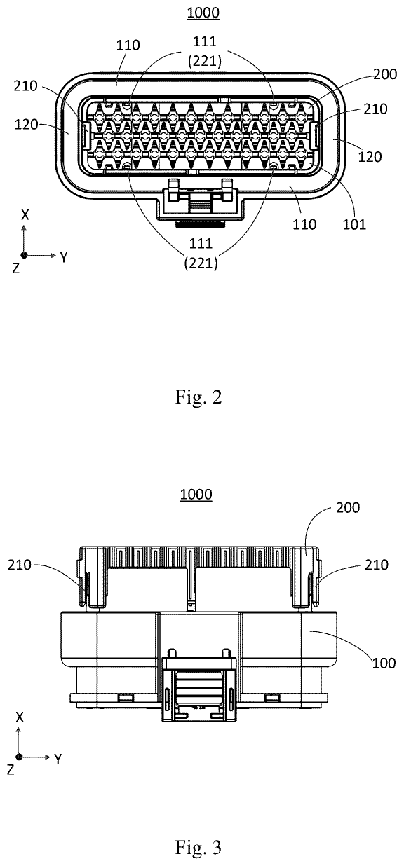

According to the exemplary embodiments of the present disclosure, as shown in FIGS. 1 to 6, in the connector assembly 1000, the housing 100 is provided with a port 101. The port 101 is defined by both a pair of first sides 110 of the housing 100 separated in a first direction X and a pair of second sides 120 of the housing 100 separated in a second direction Y perpendicular to the first direction X, as shown in FIG. 2. The terminal position locking device 200 is detachably inserted into the port 101 of the housing 100 in a third direction Z perpendicular to both the first direction X and the second direction Y.

As shown in FIGS. 1, 3 and 6, outer surfaces of the pair of second sides 120 of the housing 100 are provided with a block 121, respectively; and the terminal position locking device 200 is provided with locking hook arms 210, the locking hook arms 210 being provided on opposite sides of the terminal position locking device 200, respectively. When a hook portion 211 of the locking hook arm 210 abuts against the block 121, the terminal position locking device 200 is in the pre-locking position L1 relative to the housing 100. With the abutment between the hook portion 211 of the locking hook arm 210 and the block 121, the terminal position locking device 200 can be stably locked in the port 101 of the housing 100, so that the terminal position locking device 200 is stably in the pre-locking position LI relative to the housing 100 (as shown in FIG. 4). In the connector assembly 1000, the terminal position locking device 200 can stably be in the pre-locking position L1 relative to the connector housing 100 during factory delivery, which facilitates the smooth insertion of the terminal by the user.

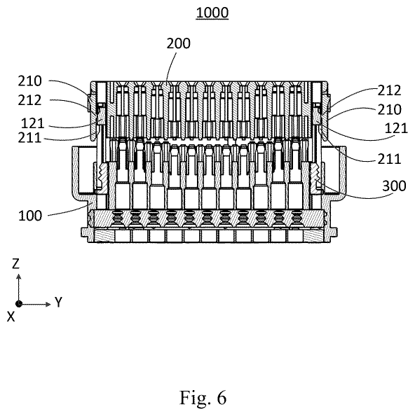

According to the exemplary embodiments of the present disclosure, as shown in FIGS. 1 to 6, in the terminal position locking device 200, the locking hook arm 210 is provided with a protruding pivot point 212. As shown in FIG. 6, the locking hook arm 210 is configured such that, when the hook portion 211 of the locking hook arm 210 abuts against the block 121, the pivot point 212 abuts against the block 121, so that the locking hook arm 210 can be pivoted around the pivot point 212 under an action of an external force, and the hook portion 211 of the locking hook arm 210 is disengaged from the block 121. The terminal position locking device 200 thereby leaves the pre-locking position L1, facilitating the user to separate the terminal position locking device 200 from the port 101 of the housing 100.

In another embodiment, in the terminal position locking device 200, the locking hook arm 210 may be provided with no protruding pivot point 212. That is, the locking hook arm 210 is configured such that, when the hook portion 211 of the locking hook arm 210 abuts against the block 121, an inner surface of the locking hook arm 210 is in contact with the block 121, and the locking hook arm 210 can be pivoted around the block 121 under an action of an external force, so that the hook portion 211 of the locking hook arm 210 is disengaged from the block 121, such that the terminal position locking device 200 leaves the pre-locking position, thereby enabling the terminal position locking device 200 to be separated from the port 101 of the housing 100.

According to the exemplary embodiments of the present disclosure, the block 121 may be formed integrally with the housing 100, and the locking hook arm 210 may be formed integrally with the terminal position locking device 200.

Therefore, in the connector assembly 1000, the terminal position locking device 200 can be restored from the final-locking position L2 to the pre-locking position L1 and/or separated from the port of the housing 100 with less force and no use of additional tools, so as to facilitate the use and/or maintenance of the connector assembly 1000 by the user.

According to the exemplary embodiments of the present disclosure, as shown in FIGS. 4 to 5, the terminal position locking device 200 is interference-fit with the inner surfaces of the pair of first sides 110 in the first direction X in the connector assembly 1000. According to the present disclosure, the interference fitting herein can select an appropriate interference amount so that a relatively tight fit is maintained between the terminal position locking device 200 and the port 101 of the housing 100 during insertion of the terminal position locking device 200 into the port 101 of the housing 100 (including the pre-locking position L1 and the final-locking position L2 to be described in detail below).

According to the exemplary embodiments of the present disclosure, as shown in FIGS. 1 to 6, in the connector assembly 1000, a stopping rib 111 is provided on the inner surface of each first side 110, and a stopping protrusion 221 is provided on an outer surface of the terminal position locking device 200 that is interference-fit with the inner surface of each first side 110. As shown in FIG. 4, when the stopping protrusion 221 interferes with a first end 111a of the stopping rib 111, the terminal position locking device 200 is in the pre-locking position L1 relative to the housing 100. As shown in FIG. 5, after the stopping protrusion 221 goes across the stopping rib 111 and interferes with a second end 111b of the stopping rib 111 opposite to the first end 111a, the terminal position locking device 200 is in the final-locking position L2 relative to the housing 100. It should be noted that, in the exemplary embodiments shown, when the stopping protrusion 221 interferes with the first end 111a of the stopping rib 111, the hook portion 211 of the locking hook arm 210 abuts against the block 121, and at this moment, the terminal position locking device 200 is in the pre-locking position LI relative to the housing 100.

In the illustrated exemplary embodiments, as shown in FIGS. 4 and 5, the stopping rib 111 has a long strip structure extending in the third direction Z, and the first end 111a and the second end 111b of the stopping rib 111 are both sloped portions that obliquely extend to the inner surface of the first side 110. It should be noted that the shapes of the stopping rib 111 and the stopping protrusion 221 are not limited to those shown in the exemplary embodiments of the present disclosure, but may be specifically designed according to specific circumstances.

According to the exemplary embodiments of the present disclosure, as shown in FIG. 2, two or more stopping ribs 111 are provided on the inner surface of each first side 110, and the two or more stopping ribs 111 are spaced apart in the second direction Y. In addition, a corresponding number of stopping protrusions 221 may be provided at corresponding positions on the outer surface of the terminal position locking device 200. According to other embodiments, a single stopping protrusion 221 across the outer surface of the terminal position locking device 200 may also be provided at a corresponding position on the outer surface of the terminal position locking device 200. It should be noted that the number and shape of the stopping protrusion 221 are not limited to those shown in the exemplary embodiments of the present disclosure, but may be specifically designed according to specific circumstances. In an embodiment, the stopping protrusion 111 is formed integrally with the housing 100.

According to the exemplary embodiments of the present disclosure, as shown in FIGS. 4 to 6, a sealing ring 300 is positioned in the port 101 of the housing 100, and is used to seal an engagement interface between the housing 100 and the terminal position locking device 200.

It should be noted that, although it is not explained and illustrated in the present disclosure, the connector assembly 1000 provided by the present disclosure further includes components such as a connector positioning locking device, a back cover, and a sealing gasket, according to actual design requirements.

According to the connector assembly of the various foregoing embodiments of the present disclosure, the terminal position locking device can be stably in the pre-locking position relative to the connector housing during factory delivery, which facilitates the smooth insertion of the terminal by the user. In addition, according to the connector assembly of the various foregoing embodiments of the present disclosure, the terminal position locking device can be restored from the final-locking position to the pre-locking position and/or separated from the port of the housing with less force and no use of additional tools, so as to facilitate the use and/or maintenance of the connector assembly by the user.

It should be appreciated by those skilled in the art that the above embodiments are intended to be illustrative, and many modifications may be made to the above embodiments by those skilled in the art. Further, various structures described in various embodiments may be freely combined with each other without conflicting in configuration or principle.

Although the present disclosure has been described hereinbefore in detail with reference to the accompanying drawings, it should be appreciated that the disclosed embodiments in the accompanying drawings are intended to illustrate the embodiments of the present disclosure by way of example, and should not be construed as a limitation to the present disclosure.

Although some embodiments of the general inventive concept of the present disclosure have been shown and described, it would be appreciated by those skilled in the art that changes or modification may be made to these embodiments without departing from the principles and spirit of the general inventive concept, the scope of which is defined in claims and their equivalents.

It should be noted that, the word “comprise” or “include” doesn't exclude other elements or steps, and the word “a” or “an” doesn't exclude more than a plurality. In addition, any reference numerals in the claims should not be interpreted as the limitation to the scope of the present disclosure.

1. A connector assembly, comprising:
a housing having a port, the port being defined by both a pair of first sides of the housing separated in a first direction and a pair of second sides of the housing separated in a second direction perpendicular to the first direction, a pair of outer surfaces of the pair of second sides of the housing are each provided with a block; and
a terminal position locking device detachably inserted into the port of the housing in a third direction perpendicular to both the first direction and the second direction, the terminal position locking device has a locking hook arm disposed on each of a pair of opposite sides of the terminal position locking device, the terminal position locking device is in a pre-locking position relative to the housing when a hook portion of the locking hook arm abuts against the block.

2. The connector assembly of claim 1, wherein, when the hook portion of the locking hook arm abuts against the block, an inner surface of the locking hook arm is in contact with the block, and the locking hook arm is pivotable around the block under an action of an external force so that the hook portion of the locking hook arm is disengaged from the block.

3. The connector assembly of claim 2, wherein, when the hook portion of the locking hook arm is disengaged from the block, the terminal position locking device leaves the pre-locking position, and the terminal position locking device is separable from the port of the housing.

4. The connector assembly of claim 1, wherein the locking hook arm has a protruding pivot point.

5. The connector assembly of claim 4, wherein, when the hook portion of the locking hook arm abuts against the block, the protruding pivot point abuts against the block, and the locking hook arm is pivotable around the protruding pivot point under an action of an external force so that the hook portion of the locking hook arm is disengaged from the block.

6. The connector assembly of claim 5, wherein, when the hook portion of the locking hook arm is disengaged from the block, the terminal position locking device leaves the pre-locking position, and the terminal position locking device is separable from the port of the housing.

7. The connector assembly of claim 1, wherein the block and the housing are integrally formed.

8. The connector assembly of claim 1, wherein the terminal position locking device is interference-fit with a pair of inner surfaces of the pair of first sides in the first direction.

9. The connector assembly of claim 1, wherein a stopping rib is disposed on an inner surface of each of the pair of first sides of the housing.

10. The connector assembly of claim 9, wherein a stopping protrusion is disposed on an outer surface of the terminal position locking device, the stopping protrusion is interference-fit with the inner surface of each of the pair of first sides of the housing.

11. The connector assembly of claim 10, wherein, when the stopping protrusion interferes with a first end of the stopping rib, the terminal position locking device is in the pre-locking position relative to the housing.

12. The connector assembly of claim 11, wherein, when the stopping protrusion moves across the stopping rib and interferes with a second end of the stopping rib opposite to the first end, the terminal position locking device is in a final-locking position relative to the housing.

13. The connector assembly of claim 12, wherein the stopping rib has a long strip structure extending in the third direction.

14. The connector assembly of claim 13, wherein the first end and the second end of the stopping rib are each a sloped portion that obliquely extends to the inner surface of one of the pair of first sides.

15. The connector assembly of claim 12, wherein the stopping rib is one of a plurality of stopping ribs on the inner surface of each of the pair of first sides of the housing, the plurality of stopping ribs on each of the pair of first sides are spaced apart in the second direction.

16. The connector assembly of claim 15, wherein the stopping protrusion is one of a plurality of stopping protrusions on the outer surface of the terminal position locking device, a number of the stopping protrusions corresponds to a number of the stopping ribs and the stopping protrusions are disposed on the terminal position locking device at positions corresponding to the stopping ribs.

17. The connector assembly of claim 12, wherein the stopping rib and the housing are integrally formed.

18. The connector assembly of claim 1, further comprising a sealing ring positioned in the port of the housing and sealing an engagement interface between the housing and the terminal position locking device.
